(19) United States
(12) Patent Application Publication
(10) Pub. No.: US 2013/0044123 A1
(43) Pub. Date: Feb. 21, 2013

(54) USER-SPECIFIED IMAGE COLORIZATION FOR APPLICATION USER INTERFACE

(71) Applicants: Harshit Shah, Bothell, WA (US); Erik Daniel Anderson, Redmond, WA (US); Veljko Miljanic, Seattle, WA (US); Fei Xiong, Redmond, WA (US); Paul Stephen Gildea, Seattle, WA (US); Kevin Welton, Redmond, WA (US); Markus Mielke, Redmond, WA (US); Sebastian Poulose, Redmond, WA (US)

(72) Inventors: Harshit Shah, Bothell, WA (US); Erik Daniel Anderson, Redmond, WA (US); Veljko Miljanic, Seattle, WA (US); Fei Xiong, Redmond, WA (US); Paul Stephen Gildea, Seattle, WA (US); Kevin Welton, Redmond, WA (US); Markus Mielke, Redmond, WA (US); Sebastian Poulose, Redmond, WA (US)

(73) Assignee: MICROSOFT CORPORATION, Redmond, WA (US)

(21) Appl. No.: 13/210,381

(22) Filed: Aug. 16, 2011

(51) Int. Cl. G06T 11/40

(52) U.S. Cl. 345/594

(57) ABSTRACT

Techniques involving dynamic colorization of graphical user interfaces. One representative technique includes enabling a user to specify colors in which user interface elements will be colored in an application. An application colorization service is initiated in response to the user specification of the colors, which is used at least to obtain the colors specified by the user, and to create bitmap images of the application's user interface elements using the user-specified colors. A bitmap image output location is made accessible to the application to enable the application to retrieve the created bitmap images, and present the application using the application user interface elements having the user-specified colors.

### BACKGROUND

Computing devices, ranging from large-scale computing devices to small handheld devices, typically provide their users with at least one visual interface. Graphical user interfaces (GUIs) generally provide the user with a visual presentation of the application or other program in use, and may additionally provide the user with manners to visually interact with the application or other program. GUIs and other computing system visual presentations are often provided in color. Various parts or areas of the GUI may be presented in certain colors, and/or by way of a color scheme. Examples of color schemes include visual styles or themes, where the appearance of visual controls, graphical appearance details, and/or other visual items may be presented in certain colors and color combinations.

In some cases, a theme could be changed to select one of a plurality of pre-designed themes that might color just some part of a GUI, such as presentation block title bars and borders. Such a solution only enables selection of pre-designed color combinations, and does not enable users to specify desired colors. Users may want to change the color of the user interface for various reasons. For example, the user may simply want to a more personally pleasing color combination. In another example, users may have visual impairments, whether it be low vision capabilities, the inability to see certain colors very well, etc. For example, certain users having some sort of visual impairment may benefit from high contrast visual presentations, whether of the same color or a variety of colors. High contrast may involve, for example, sufficiently contrasting colors between foreground and background portions of user interface elements to provide that particular user the ability to discern relevant text, glyphs and/or other informative indicia.

Changing the foreground and/or background color of individual user interface items on computer applications and other programs could place a burden on application developers. For an application color to be changed, application developers would need to obtain and apply color metrics manually in order to provide an application element of a certain color. Thus, application developers may need to assume the responsibility of drawing boxes or other shapes of certain colors for the application user interface elements in order to create the user interface. Thus, applications themselves may need to obtain color metrics and/or use graphics application programming interfaces (APIs) to actually draw the user interface elements. Further, selection of one of a plurality of pre-designed global color themes limits the ability of the user to select the particular colors in which applications will be presented. Changing global color themes may only change certain user interface elements such as a title bar or border, without affecting buttons and other graphical user interface elements of the application itself.

### SUMMARY

Techniques involving colorization of graphical user interfaces. One representative technique includes a computer-implemented method, where functions of the method are carried out by a system having processing/computing capabilities. The representative technique includes facilitating user specification of colors in which user interface elements will be colored in an application. An application colorization service is initiated in response to the user specification of the colors, which is used at least to obtain the colors specified by the user and create bitmap images of the application's user interface elements using the user-specified colors. A bitmap image output location is made accessible to the application to enable the application to retrieve the created bitmap images.

Another representative embodiment is directed to an apparatus having a user interface configured to enable a user to specify colors for application elements presentable via an application. A memory stores the user-specified colors for the application elements. A processor is configured to retrieve the stored colors, create graphical images for the application elements having the user-specified colors, enable access to the created graphical images by the application, and to execute the application to present the application elements using the created graphical images having the user-specified colors.

In still another representative embodiment, a method for colorizing user interface elements is embodied in instructions that are executable by a computing system and stored on computer-readable media. When executed, the instructions of the method facilitate user specification of one or more background colors, and one or more foreground colors, in which user interface elements will be respectively colored as background and foreground user interface elements in an application. The background and foreground colors may be stored as part of the system metrics. Size characteristics pertaining to the user interface elements are received from the application. A service module is provided to obtain the user-specified background and foreground colors for the user interface elements from the system metrics, create a bitmap image(s) using at least the size characteristics and the background and foreground colors, and store the created bitmap image(s) where it is accessible to the application for its use in presenting the user interface elements via the application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram generally illustrating a representative manner in which an application user interface may be colorized in accordance with the disclosure;

FIG. 2 is a flow diagram illustrating one representative method for colorizing application user interfaces in accordance with the disclosure;

FIG. 3 is a flow diagram illustrating a representative technique for colorizing UI elements intended to be used as background elements of an application UI;

FIG. 4 is a flow diagram illustrating a representative technique for colorizing UI elements intended to be used as foreground elements of an application UI;

FIGS. 5A and 5B are block diagrams illustrating representative embodiments for facilitating user-specified application UI colorization in accordance with the disclosure;

FIG. 6 is a flow diagram illustrating a representative method and exemplary alternatives for colorizing application user interfaces;

FIG. 7A illustrates a representative graphical user interface depicting examples of how a user may specify colors for the application UI elements;

FIG. 7B depicts a representation of an application screen that includes one or more application UI elements that can be selected by the user for color selection;

FIG. 8 is a flow diagram illustrating a representative manner for colorizing both foreground and background application UI elements; and

FIG. 9 depicts a representative computing system in which the principles described herein may be implemented.

### DETAILED DESCRIPTION

In the following description, reference is made to the accompanying drawings that depict representative implementation examples. It is to be understood that other embodiments and implementations may be utilized, as structural and/or operational changes may be made without departing from the scope of the disclosure.

The disclosure is generally directed to graphical user interface colorization. An application user interface (UI) operating on a computing system(s) may be colorized in accordance with the disclosure. As noted above, one manner of changing application user interface (UI) colors is by way of visual styles or themes, which may change the color combination of all visual presentations. In such cases, users cannot specify particular colors, color combinations, contrasting colors for use in connection with applications they are using. Further, as high contrast or other color combinations may involve specifying both a foreground and background color of an application UI element, global color themes do not enable such user-specified granularity.

In order to change certain application UI elements, the application may be responsible for obtaining colors from system metrics or elsewhere, and using graphics primitives or APIs to actually draw application UI shapes of the obtained colors. Application UI elements, colorized according to user preferences, have not been centrally available to applications to relieve them of the responsibility of colorizing the application UI elements themselves. Further, in the context of high contrast solutions, predictable colorization cannot be applied to an arbitrary bitmap (or other similar image) used for application UI to ensure a specified contrast ratio between the background and foreground elements of a UI element.

To address these and other problems, the present disclosure provides techniques for colorizing graphical user interfaces in applications or other programs involving a graphical display. In one embodiment, a user can specify which one or more colors to be applied to the background and/or foreground of UI elements of an application(s). In one embodiment, the application UI colorization occurs at runtime of the application, and involves generating one or more bitmaps of the color(s) specified by the user. The desired colors or color combinations may be selected for any purpose, such as graphical aesthetics, high contrast or particular color combinations for the visually impaired, etc. Applications can obtain bitmaps for its application UI elements from a central repository that creates the bitmaps according to at least the user-specified colors, and in some embodiments also according to other characteristics (e.g. size) specified by the application itself.

Various embodiments below are described in terms of “bitmaps.” It should be recognized, however, that the principles described herein are equally applicable to any bitmap, pixmap or other image file format used to store digital images. Thus, while the term “bitmap” is used in connection with various representative descriptions throughout the disclosure, it is a representative type of image file format, and the disclosure is not limited thereto. For example, embodiments described herein could be applied to primitive drawing as well, such as functions used for lines, arcs, text, etc.

As described in embodiments below, given at least a set of color metrics designated by a user and sizing information provided by an application, bitmaps or other images may be generated to correspond to the provided color and sizing information. Such generated bitmaps may be applied to the UI of the application that provided the sizing metrics, and/or to another applications(s). Some embodiments also involve applying the color metrics to bitmaps or other images based on image combinations to create an appearance of some level of transparency (e.g. based on an alpha channel) of each pixel in the bitmap, which can provide a consistent colorization across the bitmap. For example, some embodiments described herein involve techniques to enable generation of bitmaps based on color and sizing metrics to be used as background elements in an application UI, and enable application of color to a bitmap based on an alpha channel of each pixel in the bitmap to be used as foreground elements in the application UI.

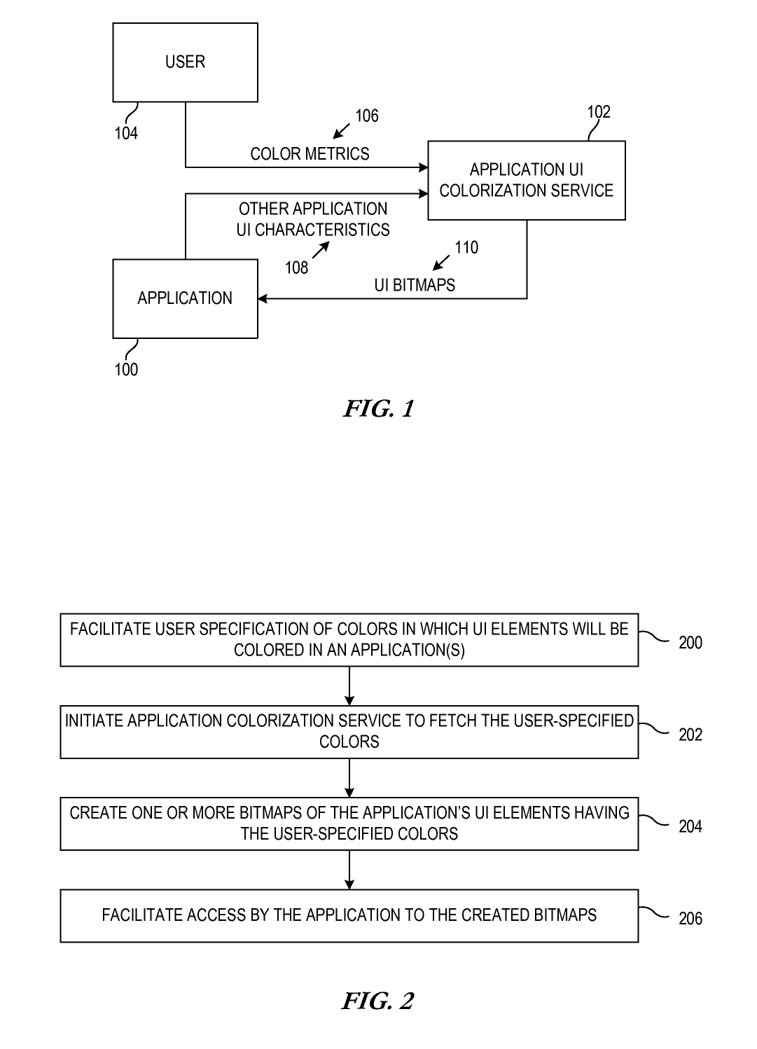

FIG. 1 is a block diagram generally illustrating a representative manner in which an application user interface (UI) may be colorized in accordance with the disclosure. In the illustrated embodiment, one or more application UI elements associated with the application 100 are to be colored. The application 100 represents any type of computer application, program, or other computer processes involving the use of a graphical display. The application 100 can access application programming interfaces (APIs) or otherwise communicate with the application UI colorization service 102. A user 104 is allowed to enter desired color information, shown as color metrics 106 in FIG. 1, which is obtained by the application UI colorization service 102. In one embodiment, the application 100 provides other application UI characteristics 108, such as the size of a desired bitmap or other image. In response to at least the user-specified color metrics 106, and in one embodiment also in response to the bitmap size and/or other application UI characteristics 108 provided by the application 100, one or more UI bitmaps 110 are provided by the application UI colorization service 102 to the application 100. The UI bitmaps 110 are created with the color identified via the color metrics 106 as specified by the user 104. The UI bitmaps 110 may also be created to a size requested by the application 100 by way of the application UI characteristics 108 provided to the application UI colorization service 102.

Thus, rather than a developer using graphics primitives to provide color on application UI elements of application 100, the application can use the application UI colorization service 102. Prior to use of such an application UI colorization service 102 as described herein, applications themselves would have to fetch color metrics, and boxes or other UI elements were drawn to create the UI element. The techniques described herein abstract such functions away from the applications, and enable service-based generation of bitmaps that are colorized based on user-specified metrics.

More particularly, the user 104 may request a bitmap 110, that represents some sort of UI element for the application 100, from the application UI colorization service 102. As an example, a user 104 can specify color information, such as by way of a control panel feature or other user interface. The user 104 could specify, for example, that UI buttons are to be dark blue, and text on the buttons will be white. The application UI colorization service 102 will extract the colors from the color metrics 106. Using the extracted colors, the application UI colorization service 102 can generate the bitmap 110 that has the user-specified colors for items such as, for example, the background color, border color and/or other color for the UI element. The service 102 delivers or otherwise makes that bitmap 110 available to the caller, which may be the application 100 or developer thereof, which will in turn apply it to the application 100 UI. Thus, among other things, the techniques described herein enable the generation of UI bitmaps, by way of a callable service that colorizes UI elements based on user-specified metrics.

In this manner, the application 100 can present its UI as a set of bitmaps or other image files without having to go to the detail of what the color of the UI element should be when a user changes the color. As noted above, the application UI colorization service 102 can provide a bitmap 110 that looks like the desired UI element—e.g., a button colored as specified by the user 104. While a size of the UI element could be specified by the user 104, in one embodiment the color is defined by the end user 104 while the size of the UI element is defined by the application 100 that is using the application UI colorization service 102. Thus, among other things, techniques described in the disclosure enable applications to call a service that generates bitmaps for application UI elements based at least in part on user input. The application can take those generated bitmaps from the service rather than generating the bitmaps itself.

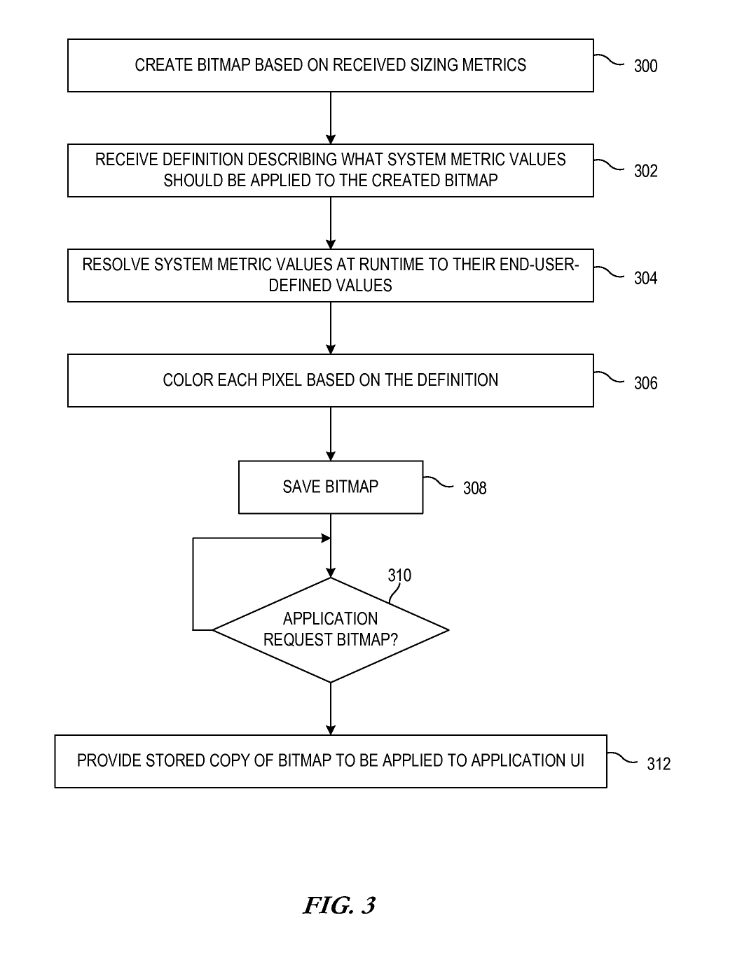

FIG. 2 is a flow diagram illustrating a representative method for colorizing application user interfaces in accordance with the disclosure. In this example, the method involves facilitating user specification of colors in which UI elements will be colored in an application(s), as shown at block 200. An application colorization service is initiated to fetch or otherwise obtain the user-specified colors, as shown at block 202. Block 204 depicts that one or more bitmaps of the applications UI elements having the user-specified colors are created. Access by the application to the created bitmaps is facilitated at block 206, such as by the service providing the created bitmaps to the requesting application, or by providing the created bitmaps at a location from which the application can fetch or otherwise access them.

The technique of FIG. 2 illustrates an exemplary technique to generate a bitmap by colorizing UI elements based on user metrics. The user may choose to change the colors of UI elements of an application for any number of reasons. For example, the user may choose to change the colors to provide a more aesthetically pleasing display. Another example is to provide high contrast application UI colorization. For example, certain end users may have a visual impairment or other vision needs, whereby the user-specified colorization in accordance with the disclosure may serve as an accessibility setting. If it is difficult for the user to see or distinguish colors with the system or default color settings, the user can change the colors to something easier for the user to see. High contrast settings are one example, such as creating black text on a white background or vice-versa, or other high contrast settings. In one embodiment, applying user-specified color metrics in this fashion can enable the contrast ratio (or any colors) to be changed for any or all of the applications in the system to better accommodate their low vision needs.

In one embodiment, the end user supplies color metrics to the system. This may be accomplished in various manners, such as by applying a theme or other visual style to the system, or creating a custom theme/visual style, and applying that to the system through a system-provided control user interface. When such a theme is applied, it in turn applies the color metrics to system metrics and requests that the visuals for the application UI be updated. Once the request is sent, the service will begin to generate bitmaps and apply color and sizing metrics to these bitmaps which can then be consumed by application UI executing on the system.

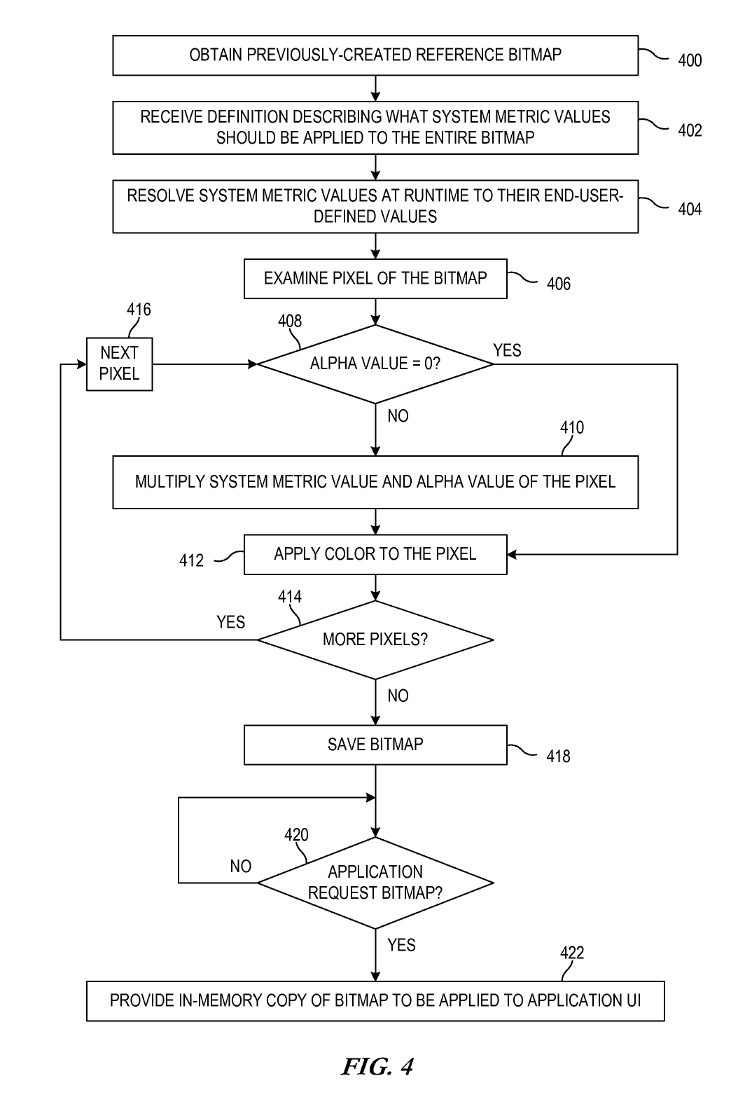

In accordance with the disclosure, both background and foreground elements of a UI component may be specified by the user. FIG. 3 is a flow diagram illustrating a representative technique for colorizing UI elements intended to be used as background elements of an application UI. In this example, a bitmap is created based on received sizing metrics as shown at block 300. For example, in one embodiment, the system creates the bitmap based on default sizing metrics provided by way of an XML-based markup. At block 302, a definition describing what system metric values may be applied to the created bitmap is received. For example, the XML-based markup can provide the definition that describes what system metric values may be applied to the generated bitmap. At block 304, system metric values may be resolved to their end-user-defined values at runtime. Each pixel may then be colored based on the definition, such as the definition provided by the XML-based markup, as shown at block 306. The bitmap may then be saved in memory or other storage entity as shown at block 308. In one embodiment depicted at block 312, any application requesting the bitmap to be applied to its UI will receive the stored copy to be applied to its UI. One embodiment involves storing the bitmap in memory at block 308, where block 312 then involves retrieval of the “in memory” copy of the bitmap by the requesting application to enable the requesting application to apply the bitmap to its UI. In this representative manner, UI elements that are meant to be used as background complements of an application UI may be colorized.

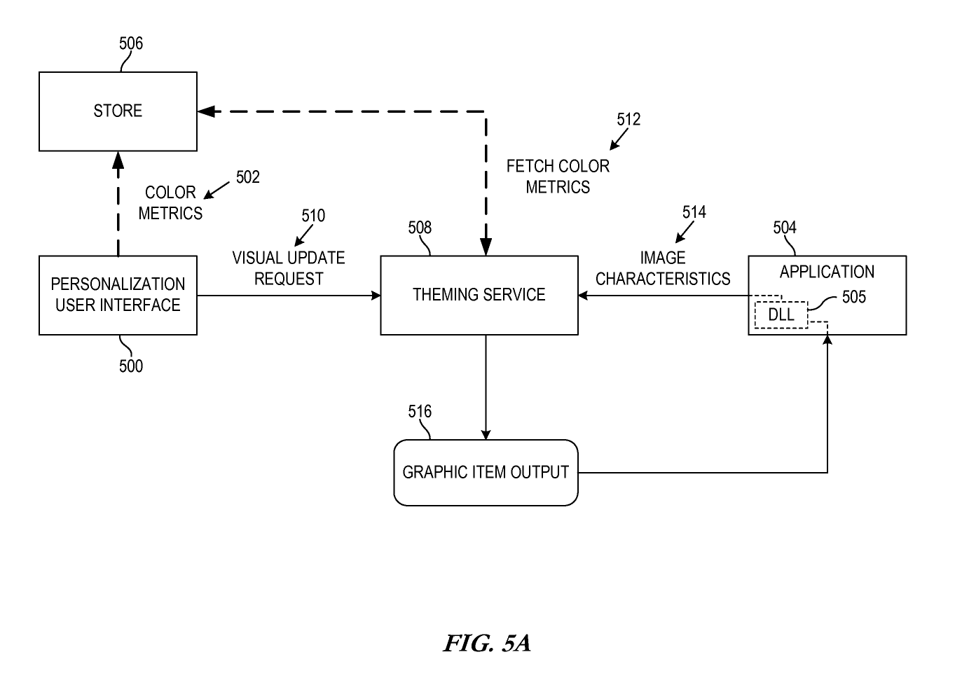

FIG. 4 is a flow diagram illustrating a representative technique for colorizing UI elements intended to be used as foreground elements of an application UI. Foreground elements may include text, glyphs or other indicia that is visually overlaid onto colored background elements. Thus, any visible element may, although does not have to, have both a background UI element and a foreground UI element. For example, an application UI button may have a background color of blue and a foreground glyph or other indicia of the UI button to be red, or the UI button have a background color of blue and foreground text on the background is red, etc. In one embodiment, a representative process to colorizing foreground UI elements may differ from a process to colorize background UI elements. Foreground UI elements may be stacked onto background UI elements, and in some embodiments the foreground elements may include some level of perceived transparency to allow varying levels of visibility of the background color through a foreground UI element. Other colors for backgrounds and/or foregrounds may include colors associated with selected text, highlighting, etc.

FIG. 4, and its difference from FIG. 3, provides an example of how foreground UI elements may be colorized differently than how background UI elements may be colorized. For UI elements that are meant to be used as foreground UI components of an application UI, a reference bitmap may be used by the system. As shown at block 400 of FIG. 4, eight previously-created reference bitmap may be obtained by the system. In one embodiment, the reference bitmap is a bitmap that is already been saved on the system. At block 402, a definition describing what system metric values may be applied to the entire bitmap is received. In one embodiment, the definition that describes what system metric values may be applied to the entire bitmap is provided by an XML-based markup. As shown at block 404, the system metric value is resolved at runtime.

Block 406 depicts that the system examines each pixel of the bitmap. In one embodiment color will be applied to the examined pixel if one or more conditions are met. It should be recognized that such conditions are not implemented in some embodiments, but in the embodiment of FIG. 4, color will be applied to pixels in the bitmap based on one or more conditions. For example, block 408 determines whether an alpha value is greater than zero. As used herein, the alpha value represents a level of transparency of a foreground UI element, thereby impacting the degree to which its background color is visible through the foreground UI element. Thus, in addition to storing a color for each foreground pixel element, an alpha value represents additional data that may be stored in an alpha channel to represent the degree of perceived transparency. In one embodiment, the alpha value as a value between zero and one, where one end of the value range indicates that the pixel is transparent, and the other end of the value range indicates that the pixel is opaque. As used herein, references to the alpha value do not suggest any particular methodology, but rather is generally used to refer to a level of transparency of the pixel in question.

In the embodiment of FIG. 4, if the alpha value is equal to zero as determined at block 408, then the color is simply applied to the pixel at block 412. On the other hand, if the alpha value is any number greater than zero (e.g. any number greater than zero and up to and including one), then the system metric value may be multiplied by the alpha value of the pixel as shown at block 410, and the result is applied to the pixel of the bitmap as depicted at block 412. If there are more pixels in the bitmap as determined at block 414, the next pixel 416 is considered in a similar manner. When each of the pixels has been considered, the bitmap is saved as shown at block 418. The bitmap may be saved in memory, storage, or any device(s) capable of temporarily or permanently storing data. Any application requesting the bitmap to be applied to its UI can receive the stored copy to be applied to its UI. This is depicted at blocks 420 and 422, where the request of the bitmap by an application results in the in-memory (or other storage) being provided to the application UI.

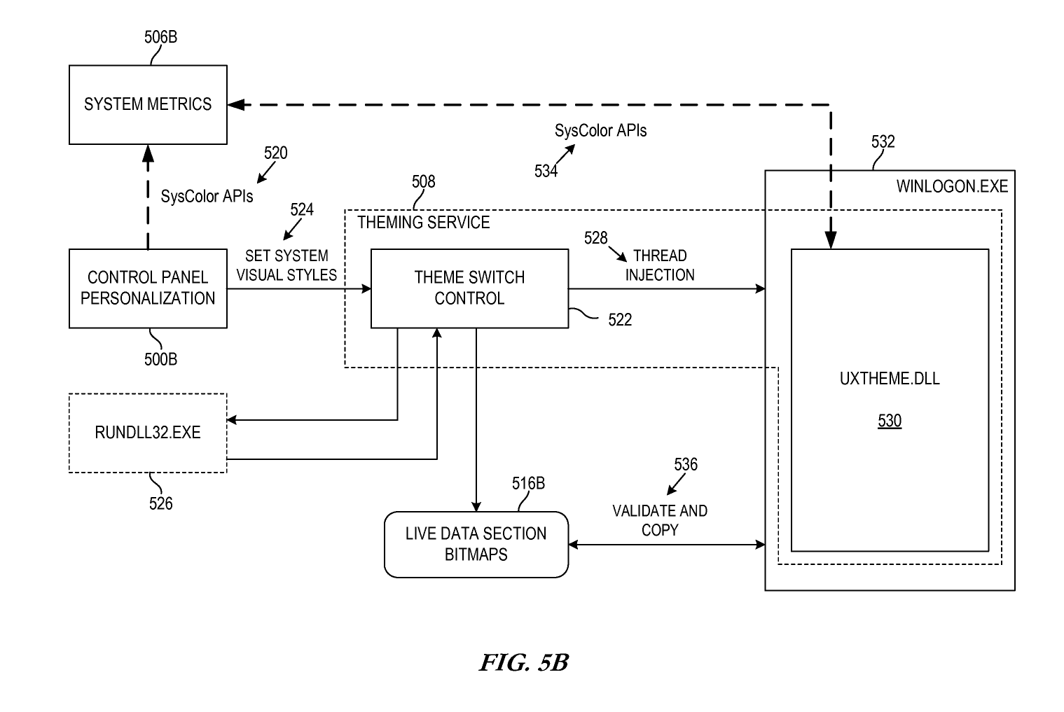

FIG. 5A is a block diagram illustrating an embodiment for facilitating user-specified application UI colorization in accordance with the disclosure. In the illustrated embodiment, a personalization user interface 500 is provided. This allows the user to specify color metrics 502 in which the application 504 UI will be colored. The personalization user interface 500 may allow for user specification of colors in any manner, such as via a graphical user interface (GUI), touch screens, text entry, voice commands, etc. In one embodiment, the color metrics 502 are stored 506, which may be stored as data in a memory/storage device, stored as part of system metrics, or the like. The user can specify colors for one or more application UI environments, such as foreground and background UI elements.

When color metrics 502 have been modified, a notification to the theming service 508 may be provided. This notification is depicted in FIG. 5A as a visual update request 510, which is a request to initiate the visual update specified by the user via the personalization user interface 500. For example, where themes or other visual styles are used, the visual update request 510 provides an indication to the theming service 508 that the theme or visual style needs to be re-loaded as a result of the user modifying the color metrics 502. In response to this request 510, the theming service 508 fetches or otherwise obtains the new color metrics 512 stored at the store 506 in order to create the bitmap(s) for the application 504 UI. As described in the embodiment of FIG. 5B below, the color metrics 502 may update system metrics which can in turn be fetched by the theming service 508.

The theming service 508 enables applications 504 to obtain bitmaps generated by the theming service 508, rather than fetching the color metrics or updated system metrics to create drawings of application UI elements themselves. In one embodiment, the application 504 provides application UI or image characteristics 514, such as bitmap size information, in any manner. Thus, in the illustrated embodiment, the size of the application UI element is defined by the application 504 using the theming service 508. For example, the application 504 can request of the theming service 508 a UI element size as part or all of the image characteristics 514, and may indicate that the application UI desired is a button that is to be three-hundred (300) pixels by forty (40) pixels. The theming service 508, having fetched the color metrics 512 and having received the size via the image characteristics 514, can generate a bitmap that is colored and sized correctly to that application request. The application 504 can obtain the generated bitmap from the graphic item output 516, and essentially paint the bitmap onto the corresponding application UI element.

While FIG. 5A depicts that the application 504 may provide the image characteristics 514 and/or obtain the graphic item output 516 in any manner, one embodiment utilizes a shared dynamically linked library (DLL) to facilitate this communication of information. For example, a DLL 505 (e.g., uxtheme.dll) may be loaded by the application 504, and the application 504 calls APIs on the DLL 505 to set image characteristics 514 and fetch graphic item output 516. In such an embodiment, there is no direct call from the application 504 to the theming service 508, but rather it is provided via the DLL 505 loaded in the application 504 process.

As noted above, the graphic item output 516 represents what is output by the theming service 508; namely, bitmaps (or other images) of the color specified by the user and the size specified by the application 504. In one embodiment, when the bitmap output is ready at the graphic item output 516, the service can notify the application 504 to redraw itself using the bitmap(s) that is now colorized to the new set of colors specified via the personalization user interface 500. Thus, the application 504 essentially consumes the new bitmaps from the graphic item output 516.

FIG. 5B is a block diagram illustrating another embodiment for facilitating user-specified application UI colorization in accordance with the disclosure. FIG. 5B includes a personalization user interface, depicted as a control panel personalization module 500B. In this embodiment, the user-specified colors are input by the user by way of a control panel or other control user interface. For example, the user can indicate to change a theme or other visual style for applications.

In one embodiment, changing the colors via the control panel personalization 500B involves changing system metrics 506B via system color application programming interfaces (SysColor APIs) 520. In one embodiment, the color selections made by the user via the control panel personalization module 500B are translated to system metrics 506B by way of the system color APIs 520. The system metrics 506B represent information such as the dimensions of various display elements, and in the illustrated embodiment also include system color metrics. Multiple system metrics may be available that will map onto certain UI components, such as background color, text or glyph color, border color, highlighting, selected text color, etc.

When the user makes a color change via the personalization module 500B, this initiates a color or theme switching action in one embodiment, which involves the theme switch control module 522. The initiation of a color/theme switch by way of user-selected colors via the control panel personalization module 500B may be accomplished by sending a notification, such as the set system visual styles notification 524, to the theme switch control module 522. This notification 524 indicates that something is being changed in the system metrics 506B due to user-specified color changes, and the notification 524 indicates that the existing theme or other visual style is to be re-loaded or otherwise switched to something else corresponding to the user's selections.

In one embodiment, a security check may be performed in connection with initiating the switching of a theme or other system colors. In the illustrated embodiment of FIG. 5B, an existing executable program, shown as the rundll32.exe 526, may be used as a canary process or other security mechanism. For example, the rundll32.exe can verify whether an invalid set of colors or metrics is provided to the theming service 508. It may run a process that if successful, will enable the theme switch control module 522 to make its request of other parts of the theming service 508 to perform the work of changing the system colors according to the user's new color definition. More particularly, once the theme switch control module 522 receives the set system visual styles notification 524, it may first invoke the rundll32.exe 526 or other security measure to perform this canary process or other security check prior to providing the thread injection notification 528 to the portions of the theming service 508 responsible for actually changing the themes/colors.

In the illustrated embodiment, at least the theme switch control module 522 and the Uxtheme dynamic link library module (Uxtheme.dll) 530 form at least part of the theming service 508 described in connection with FIG. 5A. Uxtheme.dll 530 is an example of a dynamic link library file or other executable operation that enables themes, visual styles and/or other graphical or visual presentations for applications and other items presented via computing devices. Accordingly, while the present example is described in terms of Uxtheme.dll 530, any shared dynamically linked library or analogous library may be used in the embodiment of FIG. 5B. In one embodiment, Uxtheme.dll 530 (or other analogous program) serves as a colorization update module that is modified to update the theme/colors specified by the user via the control panel personalization module 500B. The Uxtheme.dll 530 or analogous program is, in the illustrated embodiment, associated with one or more other files, such as winlogon.exe 532. Among other things, a file such as winlogon.exe 532 may be responsible for creating desktops and/or other visual presentations for a computing device, and the Uxtheme.dll 530 may be part of the winlogon.exe 532 or analogous program.

When the theme switch control module 522 is notified via the set system visual styles notification 524, a notification shown as the thread injection notification 528 informs the Uxtheme.dll 530 to start colorizing images and re-loading those images. Thus, in one embodiment, the notification 524 essentially kicks off the process of regenerating bitmaps using the system metrics 506B that the end user just set b way of the control panel personalization module 500B.

More particularly, in response to the thread injection notification 528, the Uxtheme.dll 530 or analogous program fetches the information from the system metrics 506B, which may be by way of system color APIs 534. Upon fetching at least the updated color metrics from the system metrics 506B, the modules 530/532 can begin to generate the bitmaps that will ultimately be placed in the live data section bitmaps 516B for use as application UI by the calling application (not shown). Thus, the service 508 retrieves updated system metrics 506B and generates bitmaps for application UI, thereby allowing applications to avoid having to take on these and other responsibilities.

As noted in the embodiment of FIG. 5A, an application may also provide input to the theming service 508, such as size and/or other characteristics of the bitmaps being generated for use by the calling application. In one embodiment, the theming service 508 generates bitmaps according to at least the user-specified colors and the application-specified sizes, provides the resulting bitmaps to the live data section bitmaps 516B as shown by the validate and copy operations 536. For example, the live data section bitmaps 516B represents what is output by the service 508, and may represent an area in memory or storage where the calling application can retrieve the generated bitmaps resulting from the colorization and re-loading performed by the Uxtheme.dll 530.

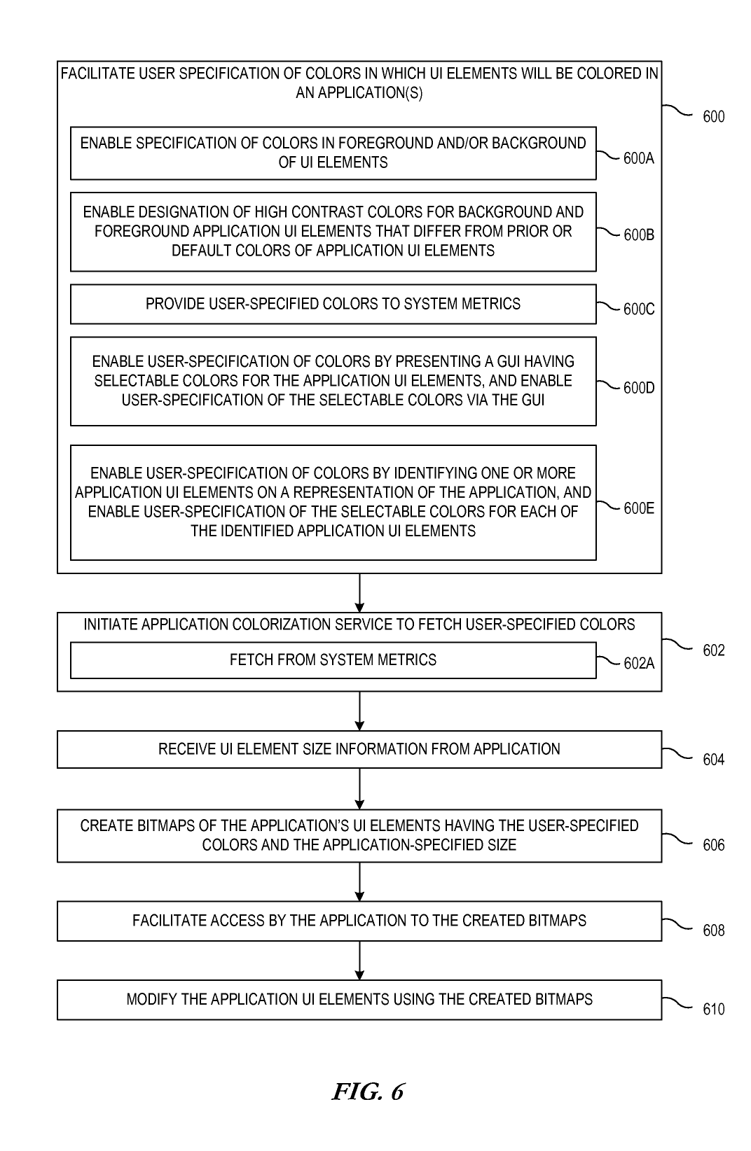

FIG. 6 is a flow diagram illustrating a representative method for colorizing application user interfaces, and exemplary alternatives that may be used on connection with the method. In this example, the method involves facilitating user specification of colors in which UI elements will be colored in an application(s) as shown at block 600. Block 600 illustrates numerous representative alternatives in which the user may specify the colors in which the application UI elements will be colored. For example, in the embodiment illustrated at block 600A, the user may be allowed to specify colors in the foreground and/or the background of application UI elements. In another embodiment shown at block 600B, the system may enable designation of high contrast colors for background and foreground application UI elements that differ from prior or default colors of application UI elements. For example, for ease of visibility or in cases of visual impairments, high contrast colors between foreground and background elements (or even between multiple UI elements in either the foreground or background) may be selected. In one embodiment, the personalization user interface may provide the user with an option to automatically select high contrast colors. As previously noted, some embodiments involve providing the user-specified colors to system metrics as shown at block 600C.

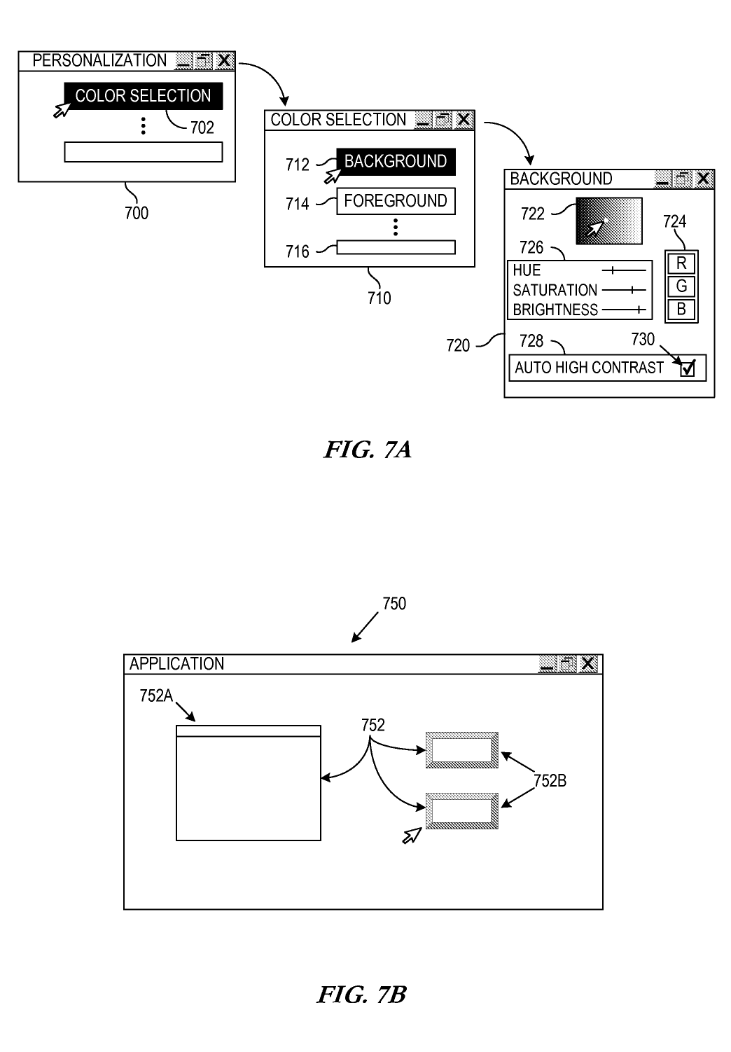

As shown at block 600D and block 600E, colors may be specified by the user in various manners. For example, block 600D shows that the user may specify colors by presenting a GUI having selectable colors for the application UI elements, and enabling the user to select the desired colors via the GUI. An example of such a GUI is shown in FIG. 7A. The example of FIG. 7A includes a first GUI shown as a personalization block 700. The personalization block 700 may be, for example, a personalization option provided in a control panel or other control interface available on a computing system. In the illustrated personalization block 700, the color selection option 702 can be selected by the user to enable the user to specify application UI colors as described herein. In one embodiment, a selection of the color selection option 702 presents a color selection block or area 710 that may include one or more color selection categories or groups, such as background colors 712, foreground colors 714, and/or other categories or groups 716.

In the embodiment of FIG. 7A, it is assumed that the user selected the background category 712, which indicates that background colors for one or more application UI elements are to be specified via graphics block 720. It should be noted however, that color specification by grouping is merely a representative option, as in some embodiments no such color groupings are used. The representative manners in which a user can specify colors shown in graphics block 720 may be used for foreground elements, background elements, and/or any other UI elements that can be colorized. Nevertheless, for purposes of illustration, the graphics block 720 depicts how colors may be specified for background application UI elements.

As shown in graphics block 720, the user may specify a color by way of a color palette 722 where the user clicks or otherwise graphically designates the desired color on the color palette 722. In another example, red, green and blue values may be entered graphically, textually, or otherwise in the RGB UI block 724. Another example shown at block 726 indicates that color may be designated based on other color characteristics such as hue, saturation, and brightness.

As previously noted, it may be desirable for ease of visibility, low vision needs, or other reasons to enable color selections such that there is a high contrast between foreground and background application UI elements. In one embodiment, an automatic high contrast UI feature 728 is provided to allow the user to let the system automatically choose high contrast colors. In one embodiment, the high contrast colors may be a default such as predominantly black and white for foreground and background coloring, or the user may be allowed to continue to rotate through a plurality of preset high contrast color combinations. In the embodiment illustrated in FIG. 7A, a checkbox 730 is presented in which a user can select to invoke the automatic high contrast feature 728.

Returning now to FIG. 6, block 600E depicts another representative manner in which the user may specify colors. In this embodiment, the user can specify colors by identifying one or more application UI elements on a representation of the application, and then select the desired colors for each of the identified application UI elements. The “representation” of the application may be for example a preview image analogous to a print preview image, a thumbnail image, a copy of a particular graphics display of the application in question, or the like. FIG. 7B depicts an example of a representation of an application screen 750 that includes one or more application UI elements 752 such as graphical blocks 752A having title bars, buttons 752B, etc. in one embodiment, the user can click on or otherwise specify the desired UI elements 752, and when selected, a color specification option such as those shown in graphics block 720 may be presented to the user. In one embodiment, the application screen 750 may be presented upon recognition by the system that the user would like to set or change the theme, visual style, or colors associated with one or more applications. For example, in one embodiment, selection by the user of a button or other color selection option 702 of FIG. 7A may present the application screen 750 of FIG. 7B.

Returning again to FIG. 6, in response to the user specifying colors, and application colorization service may be initiated as shown at block 602 in order to fetch the user-specified colors. The user-specified colors may be fetched from storage or memory, or from system metrics as shown at block 602A. In one embodiment, application UI elements size information is received from the application that is calling the service, as shown at block 604. For example, the application may involve a touchscreen embodiment in which a 500×500-pixel button is desired, in which the application may specify such a size for the resulting bitmap image. At block 606, bitmaps are created of the application's UI elements having the user-specified colors and the application-specified size.

The representative method of FIG. 6 may further involves facilitating access by the application to the newly created bitmaps as shown at block 608. For example, the colorization service can make the resulting bitmaps of the specified size and color available in memory or elsewhere to be consumed by the application that provided the size characteristics. As shown at block 610, the application may then modify its application UI elements using the created bitmaps, whereby those application UI elements will be of the size specified by the application, and the colors specified by the user.

As demonstrated in the foregoing examples, the embodiments described herein facilitate colorization of user interface elements. In various embodiments, methods are described that can be executed on a computing device, such as by providing software modules that are executable via a processor (which includes a physical processor and/or logical processor, controller, etc.). The methods may also be stored on computer-readable media that can be accessed and read by the processor and/or circuitry that prepares the information for processing via the processor. Having instructions stored on a computer-readable media as described herein is distinguishable from having instructions propagated or transmitted, as the propagation transfers the instructions versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained.

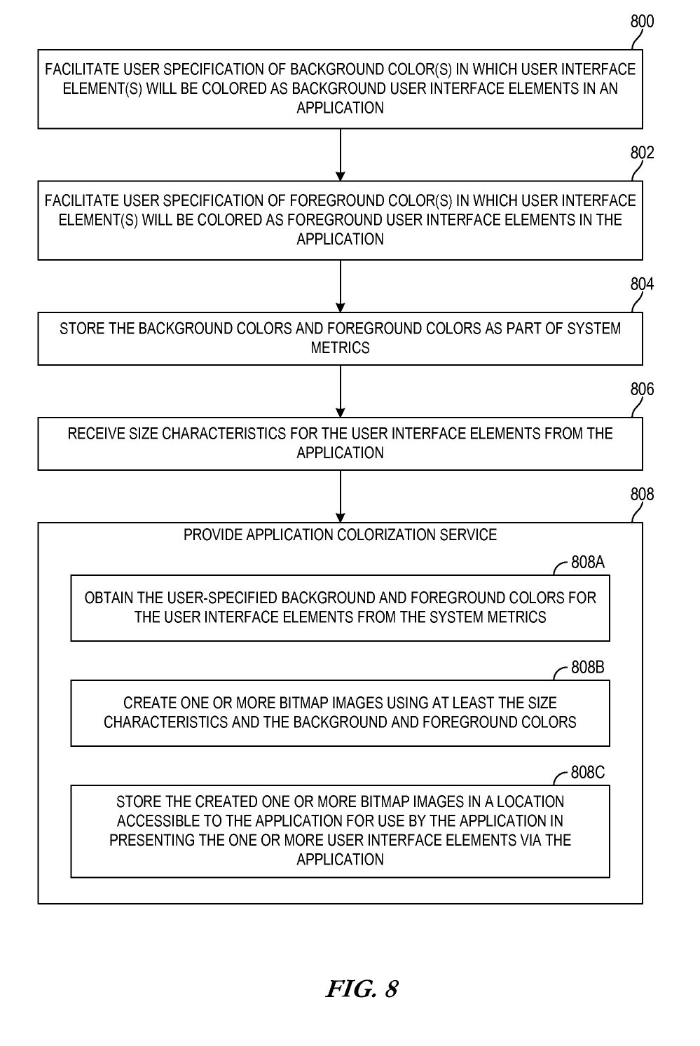

FIG. 8 is a flow diagram illustrating another embodiment of a manner for colorizing application UI elements. The flow diagram of FIG. 8, and any other methods described herein, may be implemented in software that is executable by way of a processor(s) or other computing system. For example, the method of FIG. 8 (and/or other methods/processes described herein) includes features that may be implemented in programming instructions that are stored on computer-readable media. In the embodiment of FIG. 8, block 800 shows that the user is allowed to specify background colors in which UI elements will be colored as background UI elements in an application. Block 802 shows that the user is allowed to specify foreground colors in which UI elements will be colored as foreground UI elements in the application. The background and foreground colors selected by the user are, in one embodiment, stored as part of the system metrics, as depicted at block 804. Block 806 illustrates that size characteristics for the UI elements may be received from the application.

One embodiment involves providing an application colorization service, as shown at block 808, to facilitate colorizing the application UI elements for the application that calls the application colorization service. In the embodiment of FIG. 8, providing the service may involve obtaining the user-specified background and foreground colors for the UI elements from the system metrics as depicted at block 808A. Block 808B shows that the service may create one or more bitmap images using at least the size characteristics and the background and foreground colors. As shown at block 808C, the created bitmap images may be stored in a location accessible to the application for use by the application in presenting the UI elements via the application.

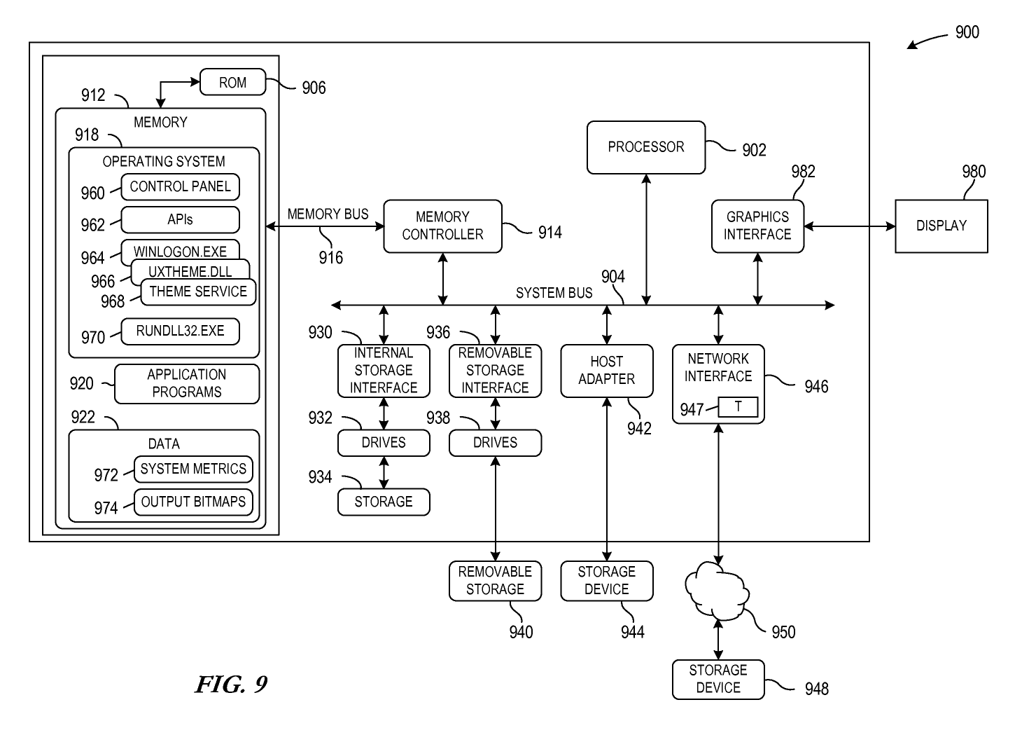

FIG. 9 depicts a representative computing system 900 in which the principles described herein may be implemented. The computing environment described in connection with FIG. 9 is described for purposes of example, as the structural and operational disclosure for enabling runtime bitmap application UI colorization is applicable in any environment in which visual images are presented. It should also be noted that the computing arrangement of FIG. 9 may, in some embodiments, be distributed across multiple devices.

The representative computing system 900 includes a processor 902 coupled to numerous modules via a system bus 904. The depicted system bus 904 represents any type of bus structure(s) that may be directly or indirectly coupled to the various components and modules of the computing environment. A read only memory (ROM) 906 may be provided to store firmware used by the processor 902. The ROM 906 represents any type of read-only memory, such as programmable ROM (PROM), erasable PROM (EPROM), or the like. The host or system bus 904 may be coupled to a memory controller 914, which in turn is coupled to the memory 912 via a memory bus 916. The exemplary memory 912 may store, for example, all or portions of the operating system 918, application programs 920 and other programs, and data 922.

Among other things, the memory controller 914 may manage the flow of data to/from the processor 902. All or portions of the operating system 918, applications 920, data 922, etc., may be stored in internal storage 934 and/or external or remote storage 940, 944, 948. Such internal storage 934 or external/remote storage 940, 944, 948 include, but are not limited to, fixed or hard disk drives (whether magnetic, solid-state, etc.), portable diskettes, compact-disk read-only memories (CD-ROMs), digital versatile discs (DVDs) and other optical storage, magnetic tape, semiconductor memories such as random-access memories (RAM), read-only memories (ROM), programmable read-only memories (PROMs), subscriber identity modules (SIMs), wireless identification modules (WIMs), etc. Relevant portions of the operating system 918, applications 920 and data 922 may be provided to memory 912 to facilitate manipulation thereof, speed of access, etc. Therefore, while the operating system 918, applications 920 and data 922, and specific items associated therewith are shown in memory 912, this is for purpose of illustration as some or all of the information may be retained in other storage components versus memory.

The operating system (OS) stored in storage and/or memory 912 may include a control panel module 960, analogous to, for example, the control panel personalization module 500B of FIG. 5B. The OS may also include APIs 962, such as the SysColor APIs 520 and 534 of FIG. 5B. Other modules of the OS 918 that are executable by the 902 include the winlogon.exe 964, Uxtheme.dll 966, theming service 968 and rundll32.exe 970 modules, which in one embodiment generally correspond to FIG. 5B's winlogon.exe module 532, Uxtheme.dll module 530, theming service 508 and rundll32.exe 526 respectively. Such modules 960-970 may be provided via the operating system 918, or other control program.

The application programs 920 may represent any applications operable on the computing system 900, including the applications that call on the application UI colorization service described herein (e.g. the theming service 968). Data 922 may also be stored in memory 912 and/or storage 934, 940, 944, such as system metrics 972 and output bitmaps 974, which in one embodiment respectively correspond to system metrics 506B and live data section bitmaps 516B of FIG. 5B.

FIG. 9 illustrates various representative storage devices in which data and/or modules described herein may be stored. For example, the system bus may be coupled to an internal storage interface 930, which can be coupled to a drive(s) 932 such as a hard drive. Storage media 934 is associated with or otherwise operable with the drives. Examples of such storage include hard disks and other magnetic or optical media, flash memory and other solid-state devices, etc. The internal storage interface 930 may utilize any type of volatile or non-volatile storage. Similarly, an interface 936 for removable media may also be coupled to the bus 904. Drives 938 may be coupled to the removable storage interface 936 to accept and act on removable media such as, for example, floppy disks, optical disks, memory cards, flash memory, external hard disks, etc. In some cases, a host adaptor 942 may be provided to access external storage 944. For example, the host adaptor 942 may interface with external storage devices via small computer system interface (SCSI), Fibre Channel, serial advanced technology attachment (SATA) or eSATA, and/or other analogous interfaces capable of connecting to external storage 944. By way of a network interface 946, still other remote storage may be accessible to the computing system 900. For example, wired and wireless transceivers 947 (which may include transmitter in addition to a receiver) associated with the network interface 946 enable communications with storage devices 948 through one or more networks 950. Storage devices 948 may represent discrete storage devices, or storage associated with another computing system, server, etc. Communications with remote storage devices and systems may be accomplished via wired local area networks (LANs), wireless LANs, and/or larger networks including global area networks (GANs) such as the Internet. The data, programs and other modules described herein may be stored in any storage or memory as described herein, or in any other component capable of storing digital information.

The colorization described herein provides different colors (and/or shades of one or more colors) for applications. The applications may be viewed on a display 980. A graphics card or other interface 982 can generate the output images to the display. The graphics interface 982 obtains the bitmaps 974 for the application via the system bus 904 or another bus. Thus, the application programs 920 can be presented on the display 980 having the system metrics 972 provided by the theming service 968 with colors specified by the user by way of the control panel module 960 or other GUI.

As demonstrated in the foregoing examples, embodiments described herein involve at least colorization of graphical user interfaces. In various embodiments, methods are described that can be executed on a computing device(s), such as by providing software modules that are executable via a processor (e.g. one or more physical processors and/or logical processors, controllers, etc.). The methods may also be stored on computer-readable media that can be accessed and read by the processor and/or circuitry that prepares the information for processing via the processor. For example, the computer-readable media may include any digital storage technology, including memory 912, storage 934, 940, 944, 948, any other volatile or non-volatile storage, etc.

Any resulting program(s) implementing features described herein may include computer-readable program code embodied within one or more computer-usable media, thereby resulting in computer-readable media enabling storage of executable functions described herein to be performed. As such, terms such as “computer-readable medium,” “computer program product,” computer-readable storage, computer-readable media or analogous terminology as used herein are intended to encompass a computer program(s) existent temporarily or permanently on any computer-usable medium.

Having instructions stored on computer-readable media as described herein is distinguishable from instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained.

Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

What is claimed is:

1. A computer-implemented method comprising:
facilitating user specification of one or more colors in which one or more user interface elements will be colored in an application;
initiating an application colorization service in response to the user specification of the one or more colors;
using the application colorization service to fetch the one or more colors specified by the user, and to create bitmap images of the application's user interface elements using the user-specified colors; and
providing a bitmap image output location accessible to the application to enable retrieval of the created bitmap images by the application.

2. The computer-implemented method as in claim 1, further comprising modifying the one or more user interface elements of the application using the created bitmap images.

3. The computer-implemented method as in claim 1, further comprising the application colorization service receiving user interface element size information from the application, and wherein using the application colorization service to create bitmap images comprises using the application colorization service to create the bitmap images having the one or more colors specified by the user and sizes corresponding to the user interface element size information received from the application.

4. The computer-implemented method as in claim 1, further comprising providing color metrics corresponding to the one or more colors specified by the user to system metrics, and wherein using the application colorization service to fetch the one or more colors comprises using the application colorization service to fetch the color metrics from the system metrics.

5. The computer-implemented method as in claim 1, wherein providing a bitmap image output location comprises providing a memory area allocated as the bitmap image output location to store the created bitmap images for access by the application for use as the user interface elements for that application.

6. The computer-implemented method as in claim 1, wherein facilitating user specification of one or more colors comprises facilitating user specification of at least one background color and at least one foreground color for at least one of the user interface elements.

7. The computer-implemented method as in claim 6, wherein facilitating user specification of at least one background color comprises enabling selection of at least one color for a background of the user interface element, and enabling selection of at least one color for text or other glyph for a foreground to overlay the background.

8. The computer-implemented method as in claim 1, wherein facilitating user specification of the one or more colors comprises presenting a graphical user interface having selectable colors for the user interface elements, and enabling the user to specify the one or more colors via the graphical user interface.

9. The computer-implemented method as in claim 1, wherein facilitating user specification of the one or more colors comprises identifying one or more of the user interface elements on a representation of the application, and enabling the user to select the one or more colors for the identified user interface elements.

10. The computer-implemented method as in claim 1, further comprising implementing the application colorization service at least in part in a shared dynamically linked library to create the bitmap images with the user-specified colors.

11. An apparatus comprising:
a user interface configured to facilitate user specification of one or more colors for one or more application user interface elements presentable via an application;
memory configured to store the user-specified one or more colors for the one or more application user interface elements; and
a processor configured to retrieve the stored one or more colors, create one or more graphical images for the one or more application user interface elements having the user-specified one or more colors, enable access to the created graphical images by the application, and to execute the application to present the one or more application user interface elements using the created graphical images having the user-specified one or more colors.

12. The apparatus of claim 11, wherein the processor is configured to create one or more graphical images by creating one or more bitmap images for the one or more application user interface elements.

13. The apparatus of claim 11, wherein the processor is further configured to create each of the graphical images in a size specified by the application, and to execute the application to present the one or more application user interface elements using the created graphical images having the user-specified one or more colors and the size specified by the application.

14. The apparatus of claim 11, wherein the processor is further configured to apply foreground color to the created bitmap based on an alpha channel of each pixel in the bitmap.

15. The apparatus of claim 11, wherein the memory is further configured to store the created graphical images for retrieval by the application.

16. Computer-readable media having instructions stored thereon which are executable by a computing system for performing steps comprising:
facilitating user specification of one or more background colors in which one or more user interface elements will be colored as background user interface elements in an application;
facilitating user specification of one or more foreground colors in which the one or more user interface elements will be colored as foreground user interface elements in the application;
storing the one or more background colors and one or more foreground colors as part of system metrics;
receiving size characteristics for the user interface elements from the application; and
providing a service to obtain the user-specified background and foreground colors for the user interface elements from the system metrics, to create one or more bitmap images using at least the size characteristics and the background and foreground colors, and to store the created one or more bitmap images in a location accessible to the application for use by the application in presenting the one or more user interface elements via the application.

17. The computer-readable media as in claim 16, wherein the computer-readable media further comprises instructions executable by the computing system for providing a graphical user interface by which the user can specify at least the one or more background colors and the one or more foreground colors for the background and foreground user interface elements respectively.

18. The computer-readable media as in claim 16, wherein the instructions for providing the service to create the one or more bitmap images further comprises instructions executable by the computing system for creating at least one of the bitmap images using at least the size characteristics, the background and foreground colors, and an alpha value for each pixel in the bitmap image.

19. The computer-readable media as in claim 16, wherein the instructions for providing the service comprises instructions executable by the computing system for providing a switch control module to recognize when the user has specified the background and foreground colors, and providing a colorization update module to modify the one or more user interface elements of the application and make the created one or more bitmap images available to the application.

20. The computer-readable media as in claim 16, wherein the instructions for providing a graphical user interface further comprise instructions executable by the computing system for facilitating user specification of the one or more foreground and background colors to be contrasting colors.
